(19) United States
(12) Patent Application Publication
(10) Pub. No.: US 2019/0371275 A1
(43) Pub. Date: Dec. 5, 2019

(54) DISPLAY CONTROL SYSTEM AND METHOD FOR AN AIRCRAFT

(71) Applicant: Airbus Operations (S.A.S.), Toulouse (FR)

(72) Inventors: Jean Serreau, Toulouse (FR); Cedric Descheemaeker, BEAUZELLE (FR); Javier Manjon Sanchez, Toulouse (FR)

(21) Appl. No.: 16/422,463

(22) Filed: May 24, 2019

(30) Foreign Application Priority Data
Jun. 1, 2018 (FR) 1854780

(51) Int. Cl. G09G 5/37; G09G 5/02; G02B 27/01; B64D 43/00

(52) U.S. Cl. CPC G09G 5/37; G09G 5/02; G02B 27/0172; G02B 2027/0141; G09G 2380/12; G09G 2320/0666; B64D 43/00

(57) ABSTRACT

A display control system for a display mounted fixedly on the head of a user in an aircraft cockpit generates a video signal to be displayed by the display on the basis of piloting assistance information to be presented to the user in the form of a graphical object. The display control system includes electronic circuitry configured to intermittently change the geometric form and/or the color of one or more parts of the graphical object. It is thus possible to combat effects of binocular rivalry.

### CROSS-REFERENCE TO RELATED APPLICATION

This application claims priority to French patent application number 18 54780 filed on Jun. 1, 2018, the entire disclosure of which is incorporated by reference herein.

### TECHNICAL FIELD

The disclosure herein relates to a display control system for an aircraft, the display system including a display intended to be worn fixedly on the head of a user in the cockpit of the aircraft. The disclosure herein also relates to a method implemented by such a system.

### BACKGROUND

Aircraft typically include a system for displaying piloting assistance information in their cockpit. Such a system, for example a CDS (control and display system), controls the displaying of information on screens, known as head-down screens, of the cockpit. Thus, to view this information, a user, generally a pilot or a co-pilot of the aircraft, has to lower his or her head in order to look at the screens when he is stationed at his post in the cockpit. It is therefore difficult or even impossible for him to view the surroundings of the aircraft through a windscreen of the cockpit at the same time. To allow a user to view this information while at the same time monitoring the surroundings of the aircraft, some aircraft are nowadays equipped with head-up display systems, commonly called HUDs. Such HUD systems each include a projector and a semi-reflective pane (combiner) positioned between the windscreen of the aircraft and a position corresponding to the position of the user's head when the user is stationed at his post in the cockpit. The projector projects the piloting assistance information onto the semi-reflective pane, and the user is thus able to view this information superimposed on the surroundings of the aircraft visible through the windscreen. However, HUD systems are fixed and therefore only partly solve the problem of viewing piloting assistance information at the same time as the surroundings of the aircraft, unless these HUD systems are duplicated at various locations of the windscreen. To mitigate this drawback and furthermore benefit from displaying information in augmented reality, some aircraft are equipped with display systems configured so as to be worn fixedly on the user's head in the cockpit. Such systems are commonly called HWD for head-worn display or HMD for head-mounted display. These HMD systems include a display mounted fixedly on the user's head, typically on a spectacle frame or headset frame, such that the user is able to see the piloting assistance information displayed on the display when he or she wears these spectacles or this headset. The display is transparent so as to allow the user to view the displayed information, potentially partly in augmented reality, superimposed on the surroundings. The piloting assistance information is then perceived by the user, regardless of the orientation of his head. Reference is made to dynamic line of sight. To allow such an augmented reality display to be achieved, the orientation of the user's head is measured by sensors and the display of the piloting assistance information is adjusted depending on the orientation of the user's head. Thus, for example, the information may not be displayed on the display of the HMD system in the same way regardless of the orientation of the pilot's head, as some information would then risk not being displayed coherently with the external surroundings of the aircraft visible to the user.

In general, HMD systems are monocular, that is to say their arrangement is such that the piloting assistance information is provided to just one of the user's two eyes. In some individuals, induced binocular rivalry leads to piloting assistance information that is displayed being difficult to perceive for the user. It is then desirable to provide a solution that makes it possible to combat these effects of binocular rivalry and thus improve the perception of piloting assistance information displayed by monocular HMD systems.

### SUMMARY

One aim of the disclosure herein is a display control system for a display mounted fixedly on the head of a user in an aircraft cockpit, the display control system generating a video signal to be displayed by the display on the basis of piloting assistance information to be presented to the user in the form of a graphical object. The display control system includes electronic circuitry configured so as to intermittently change the geometric form and/or the color of one or more parts of the graphical object. Thus, by making such form and/or color changes, the user's attention is captured, thereby making it possible to combat the effects of binocular rivalry and thus to improve the perception of the piloting assistance information displayed by binocular HMD systems.

According to one particular embodiment, to intermittently change the geometric form of one or more parts of the graphical object, the electronic circuitry is configured so as to display a discontinuity in the part or parts of the graphical object and so as to move the discontinuity over the graphical object over time.

According to one particular embodiment, to intermittently change the geometric form of one or more parts of the graphical object, the electronic circuitry is configured so as to switch part of the graphical object between unitary geometric forms.

According to one particular embodiment, to intermittently change the geometric form of one or more parts of the graphical object, the electronic circuitry is configured so as to intermittently display graphical elements complementary to a nominal graphical object.

According to one particular embodiment, the piloting assistance information to be presented to the user in the form of a graphical object are at least a flight path vector.

According to one particular embodiment, the electronic circuitry is configured so as to intermittently change the geometric form and/or the color of the part or parts of the graphical object: continuously; or in a stroboscopic manner; or in a pulsed manner.

According to one particular embodiment, the form and/or color is changed at a fixed period of between 1 and 3 seconds.

Another aim of the disclosure herein is a display system for an aircraft including a display mounted fixedly on the head of a user in an cockpit of the aircraft, the display system for an aircraft furthermore including a display control system generating a video signal to be displayed by the display on the basis of piloting assistance information to be presented to the user in the form of a graphical object. The display system therefore incorporates a display control system as outlined above.

Another aim of the disclosure herein is an aircraft including a display system for an aircraft as outlined above.

Another aim of the disclosure herein is a display control method for a display mounted fixedly on the head of a user in an aircraft cockpit, the method being implemented by a control system generating a video signal to be displayed by the display on the basis of piloting assistance information to be presented to the user in the form of a graphical object. The method is such that the display control system intermittently changes the geometric form and/or the color of one or more parts of the graphical object.

Another aim of the disclosure herein is a computer program product that is able to be stored on a medium and/or downloaded from a communication network so as to be read by a processor of the display control system outlined above. This computer program comprises instructions for implementing the abovementioned method when the program is executed by the processor. Another aim of the disclosure herein is an information storage medium on which such a computer program is stored.

### BRIEF DESCRIPTION OF THE FIGURES

The features of the disclosure herein mentioned above, along with others, will become more clearly apparent on reading the following description of at least one exemplary embodiment, the description being given with reference to the appended, example drawings, in which:

FIG. 1 shows a side view of an aircraft in which a display system including a display intended to be worn fixedly on the head of a user in the cockpit of the aircraft is installed;

FIGS. 2A through 2C schematically illustrate the display worn by the user according at various orientations of the user's head;

FIG. 3 schematically illustrates an exemplary electronic architecture of the display system;

FIG. 4 schematically illustrates an example of a graphical object generally used to represent a flight path vector;

FIGS. 5A through 5C schematically illustrate a first example of successive form changes made to a graphical object displayed via the display;

FIGS. 6A through 6D schematically illustrate a second example of successive form changes made to a graphical object displayed via the display;

FIGS. 7A through 7C schematically illustrate a third example of successive form changes made to a graphical object displayed via the display;

FIGS. 8A through 8D schematically illustrate a fourth example of successive form changes made to a graphical object displayed via the display;

FIGS. 9A and 9B schematically illustrate a fifth example of successive form changes made to a graphical object displayed via the display; and

FIGS. 10A and 10B schematically illustrate a sixth example of successive form changes made to a graphical object displayed via the display.

### DETAILED DESCRIPTION

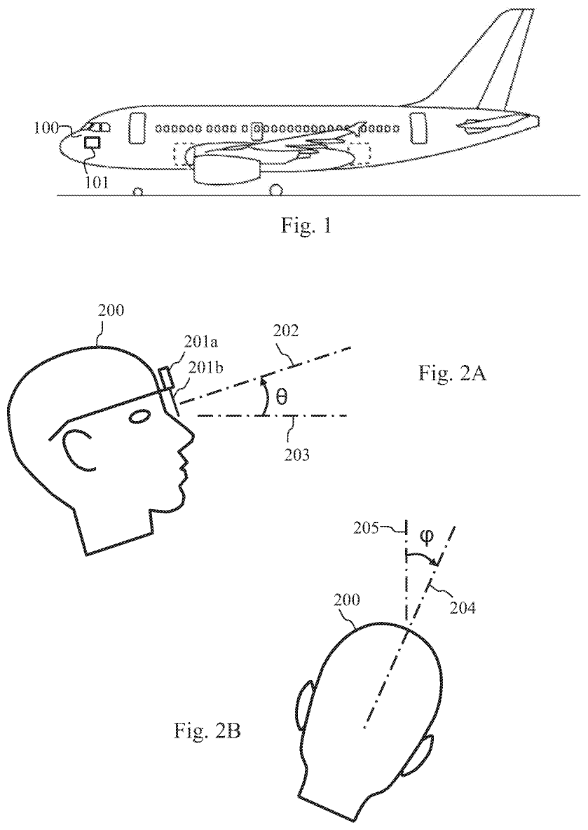

FIG. 1 shows a side view of an aircraft 100 in which an HMD display system 101 is installed. The display system 101 is monocular. The display system 101 is intended to display piloting assistance information intended for a user, be this a pilot or a co-pilot, stationed at his post in the cockpit of the aircraft 100.

The display system 101 includes a display 201b intended to be worn fixedly on the user's head 200. To this end, the display 201b is attached to a frame 201a of a support mounted fixedly on the user's head 200, such as for example the spectacle frame or the shell of a protective headset or the casing of headphones.

In one particular embodiment, the display system 101 also includes at least one sensor designed to determine the orientation of the user's head 200 in a reference frame that is fixed with respect to the cockpit, or more generally with respect to the structure of the aircraft 100. In one particular embodiment, the display system 101 thus includes a set of inertial sensors mounted fixedly on the display 201b. In another particular embodiment, the display system 101 thus includes at least one camera fixed in the cockpit and arranged so as to automatically monitor the user's head 200. The display system 101 is then configured so as to obtain information on the orientation of the user's head 200 in the reference frame fixed with respect to the cockpit or to the structure of the aircraft 100, so as to make it possible to display piloting assistance information in augmented reality.

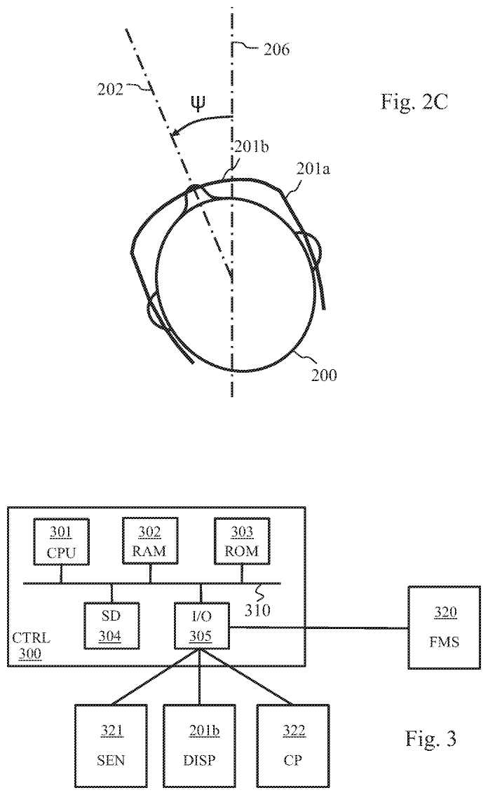

The information on the orientation of the user's head 200 corresponds to at least one angle from among a set of angles θ, φ and ψ, as illustrated in FIGS. 2A to 2C. In FIG. 2A, the orientation of the user's head 200 is defined by virtue of a pitch angle θ between a theoretical direction 202 of the user's gaze when he is looking straight ahead, without turning his eyes to the right or to the left and without raising or lowering his eyes, and a horizontal axis 203. In FIG. 2B, the orientation of the user's head 200 is defined by virtual of a roll angle φ between a direction of lateral incline 204 of the user's head 200 and a vertical axis 205. In FIG. 2C, the orientation of the user's head 200 is defined by virtual of a yaw angle ψ between the theoretical gaze direction 202 of the user 200 and an axis of movement 206 of the aircraft 100.

The display system 101 is configured so as to present piloting assistance information in the form of a graphical object to the user on the display 201b. For example, the piloting assistance information is a flight path vector (FPV). As described below, the display system 101 is configured so as to intermittently change the geometric form and/or the color of one or more parts of the graphical object, so as to combat binocular rivalry by attracting the attention of the user's brain to the display 201b.

FIG. 3 schematically illustrates an exemplary electronic architecture of the display system 101.

The display system 101 includes a control system CTRL 300 connected to the display DISP 201b and to a flight management system FMS 320. The control system CTRL 300 is furthermore optionally connected to one or more sensors SENS 321. The control system CTRL 300 is furthermore optionally connected to a control panel CP 322.

The sensor or sensors SENS 321 allow the control system CTRL 300 to obtain information on the orientation of the user's head 200, as described above.

The control panel CP 322 allows the user to send adjustment commands to the control system CTRL 300. The control system CTRL 300 then interprets the adjustment commands received from the control panel CP 322 and adjusts the display of the display 201b accordingly. Such adjustment commands are for example adjusting brightness or colorimetry. Such adjustment commands are for example commands to select or deselect piloting assistance information to be displayed via the display 201b.

The flight management system FMS 320 supplies the control system CTRL 300 with piloting assistance information to be displayed by the display 201b. The flight management system FMS 320 may supply the piloting assistance information in raw form, and then gives the control system CTRL 300 the responsibility for performing the formatting necessary to display them on the display 201b. As a variant, the flight management system FMS 320 may supply the piloting assistance information after initial formatting. The control system CTRL 300 then modifies the initial formatting undergone by the flight management system FMS 320.

In the context of the display management on the display 201b, the control system CTRL 300 recovers the piloting assistance information supplied by the flight management system FMS 320, possibly associates other piloting assistance information managed by the control system CTRL 300 itself, such as for example the information on the orientation of the user's head 200, and generates a video signal to be displayed by the display 201b.

To this end, the control system CTRL 300 includes the following, linked by a communication bus 310: a processor or CPU (central processing unit) 301; a random access memory RAM 302; a read-only memory ROM 303, for example of EEPROM (electrically erasable programmable read-only memory) type; a storage unit, such as a hard disk drive HDD, or a storage medium reader, such as an SD (secure digital) card reader 304; an input-output interface I/O 305 for connecting the control system CTRL 300 to the display 201b, to the flight management system FMS 320, to each sensor SENS 321 and to the control panel CP 322.

The processor CPU 301 is capable of executing instructions loaded into the memory RAM 302 from the memory ROM 303, from an external memory, from a storage medium (such as an SD card), or from a communication network (not shown). When the control system CTRL 300 is powered up, the processor CPU 301 is capable of reading instructions from the memory RAM 302 and of executing them. These instructions form a computer program that brings about the implementation, by the processor CPU 301, of all or some of the display management algorithms on the display 201b.

All or some of the display management algorithms 201b may thus be implemented in software form through the execution of a set of instructions by a programmable machine, for example a DSP (digital signal processor) or a microcontroller, or be implemented in hardware form by a machine or a dedicated component, for example an FPGA (field-programmable gate array) or ASIC (application-specific integrated circuit) component. In general, the display system 101 includes electronic circuitry designed to implement, in software and/or hardware form, the display management algorithms on the display 201b.

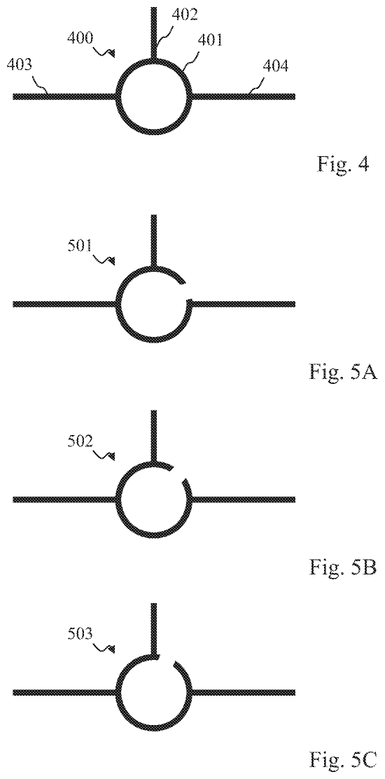

FIG. 4 schematically illustrates an example of a graphical object 400 generally used to represent a flight path vector FPV. This graphical object consists of or comprises a circle 401 starting from which three straight segments are positioned, namely: a first vertical segment 402 starting from the highest point of the circle 401 and moving away from the center of the circle 401, a second horizontal segment 403 starting from the leftmost point of the circle 401 and moving away from the center of the circle 401, and a third horizontal segment 404 starting from the rightmost point of the circle 401 and moving away from the center of the circle 401. The symbolism thus used aims to schematically represent the aircraft 100 seen from the back, the circle 401 representing the fuselage of the aircraft 100, the vertical segment 402 representing the drift of the aircraft 100, and the horizontal segments 403, 404 representing the wing structure of the aircraft 100.

To combat effects of binocular rivalry, the control system CTRL 300 intermittently changes the geometric form and/or the color of one or more parts of the graphical object 400. As a reminder, the geometric form of an object is a geometric description of a space or of a plane occupied by the object, as determined by the outer border of this object, excluding the location and orientation in space or in the plane, and its size and its color. The control system CTRL 300 intermittently changes the geometric form and/or the color the part or parts of the graphical object 400:
continuously; or
in a stroboscopic manner; or
in a pulsed manner.

When the intermittent change is performed continuously, the form and/or color is changed at a given frequency.

When the intermittent change is performed in a pulsed manner, the control system CTRL 300 switches between phases of displaying the nominal graphical object, that is to say the graphical object 400, and phases of changing the form and/or color at a given frequency. The duration of the phases of changing form and/or color is then shorter, or even much shorter (for example 10 times shorter) than that of the phases of displaying the nominal graphical object. In addition, the phases of changing form and/or color occur regularly over time. This therefore gives the impression of a regular pulse over time.

The abovementioned frequencies are chosen such that the intermittent change is perceptible to the user in order to attract the attention of the user's brain to this display, so as to combat binocular rivalry.

When the intermittent change is performed in a stroboscopic manner, the control system CTRL 300 switches between phases of displaying the nominal graphical object, that is to say the graphical object 400, and phases of changing the form and/or color at a given frequency. The duration of the phases of changing form and/or color is then shorter, or even much shorter (for example 10 times shorter) than that of the phases of displaying the nominal graphical object. In addition, the phases of changing form and/or color occur cyclically in a close manner and then in a spaced manner over time. This is like the pulsed manner, except that a plurality of temporally close pulses (for example 2 pulses) are generated per cycle, and the duration between these close pulses its equal to the duration of the pulses.

In one particular embodiment, the form and/or color is changed at a fixed period (or frequency), preferably of between 1 and 3 seconds. Combating the effects of binocular rivalry is thus improved, due to the fact that binocular rivalry is a short phenomenon typically of a duration shorter than 3 seconds. Using a fixed form and/or color changing frequency furthermore allows a deterministic behavior that avoids confusion for the user with a warning signal or an alarm.

Various embodiments, based on the flight path vector FPV, are presented below: change of form by introducing a discontinuity, change of form by substituting graphical elements, and change of form by adding graphical elements. The principles applied to the flight path vector FPV may however be applied to other piloting assistance information and/or to other graphical representations.

FIGS. 5A through 5C schematically illustrate a first example of successive form changes made to a graphical object displayed via the display 201b.

FIG. 5A shows a graphical object 501 derived from the graphical object 400. The graphical object 501 differs from the graphical object 400 in that part of the quarter circle joining the horizontal segment 404 and the vertical segment 402 is missing. A discontinuity is therefore introduced into the graphical object 400 so as to obtain the graphical object 501.

FIG. 5B shows a graphical object 502 also derived from the graphical object 400. The graphical object 502 differs from the graphical object 400 in that a different part of the quarter circle joining the horizontal segment 404 and the vertical segment 402 is missing with respect to the graphical object 501.

FIG. 5C shows a graphical object 503 also derived from the graphical object 400. The graphical object 503 differs from the graphical object 400 in that another part of the quarter circle joining the horizontal segment 404 and the vertical segment 402 is missing with respect to the graphical objects 501, 502.

By successively displaying FIGS. 5A through 5C, the discontinuity moves over the quarter circle joining the horizontal segment 403 and the vertical segment 401. The same principle may be applied to the quarter circle joining the vertical segment 402 and the horizontal segment 403, and to the lower semicircle between the horizontal segment 403 and the horizontal segment 404. It is thus possible to move the discontinuity over all or part of the circle 401.

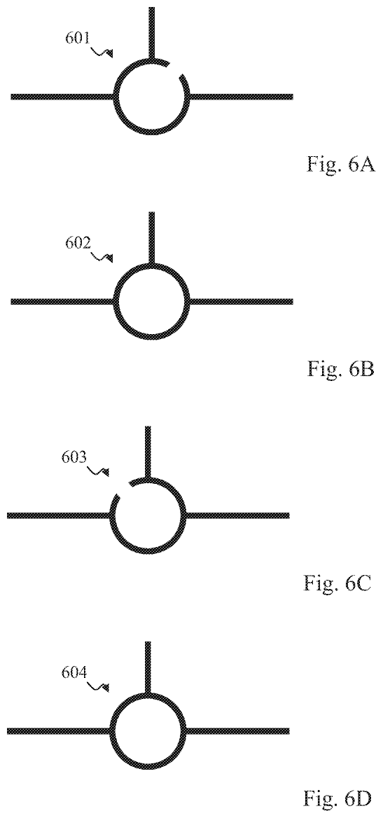

FIGS. 6A through 6D schematically illustrate a second example of successive form changes made to a graphical object displayed via the display 201b.

FIG. 6A shows a graphical object 601 derived from the graphical object 400. The graphical object 601 differs from the graphical object 400 in that part of the quarter circle joining the horizontal segment 404 and the vertical segment 402 is missing. A discontinuity is therefore introduced into the graphical object 400 so as to obtain the graphical object 601. More particularly, in FIG. 6A, the missing part is centered on the midpoint of the quarter circle joining the horizontal segment 404 and the vertical segment 402.

FIG. 6B shows a graphical object 602 corresponding to the graphical object 400.

FIG. 6C shows a graphical object 603 derived from the graphical object 400. The graphical object 603 differs from the graphical object 400 in that part of the quarter circle joining the horizontal segment 403 and the vertical segment 402 is missing. A discontinuity is therefore introduced into the graphical object 400 so as to obtain the graphical object 603. More particularly, in FIG. 6C, the missing part is centered on the midpoint of the quarter circle joining the horizontal segment 403 and the vertical segment 402. FIG. 6C therefore symmetrical with respect to FIG. 6A about a vertical axis incorporating vertical segment 402.

FIG. 6D shows a graphical object 604 corresponding to the graphical object 400.

By successively displaying FIGS. 6A through 6D, the discontinuity appears and disappears, and this discontinuity switches between the quarter circle joining the horizontal segment 404 and the vertical segment 402 and the quarter circle joining the horizontal segment 403 and the vertical segment 402. The same principle may be applied symmetrically, about the axis formed by the horizontal segments 403 and 404, to the lower semicircle between the horizontal segment 403 and the horizontal segment 404. As a variant, it is also possible to enrich the switching of the displaying of the discontinuity between the quarter circle joining the horizontal segment 404 and the vertical segment 402 and the quarter circle joining the horizontal segment 403 and the vertical segment 402, by making the discontinuity appear and disappear in the middle of the lower semicircle between the horizontal segment 403 and the horizontal segment 404.

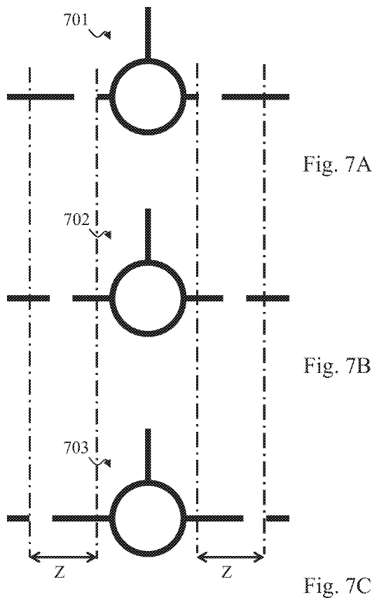

FIGS. 7A through 7C schematically illustrate a third example of successive form changes made to a graphical object displayed via the display 201b.

FIG. 7A shows a graphical object 701 derived from the graphical object 400. The graphical object 701 differs from the graphical object 400 in that part of the horizontal segment 403 is missing. The same modification is applied, symmetrically about a vertical axis incorporating the vertical segment 402, to the horizontal segment 404.

FIG. 7B shows a graphical object 702 derived from the graphical object 400. The graphical object 702 differs from the graphical object 400 in that a different part of the horizontal segment 403 is missing with respect to the graphical object 701. The same modification is applied, symmetrically about a vertical axis incorporating the vertical segment 402, to the horizontal segment 404.

FIG. 7C shows a graphical object 703 derived from the graphical object 400. The graphical object 703 differs from the graphical object 400 in that another part of the horizontal segment 403 is missing with respect to the graphical objects 701, 702. The same modification is applied, symmetrically about a vertical axis incorporating the vertical segment 402, to the horizontal segment 404.

By successively displaying FIGS. 7A through 7C, the user has the impression that the discontinuity is moving in a predefined zone Z of the horizontal segments 403, 404. The same principle may be applied to the vertical segment 402.

In one particular embodiment, FIGS. 7A through 7C are displayed successively, and then this sequence is followed by a period, for example equal to the duration of displaying of each of the representations of FIG. 7A through 7C or equal to the duration of displaying of all of the representations of FIGS. 7A through 7C, during which the graphical object 400 is displayed without a discontinuity being present.

FIGS. 5A through 5C, 6A through 6D and 7A through 7C thus show examples of display control, by the display 201b, in which the control systems CTRL 300 displays a discontinuity in one or more parts of the graphical object formed by the flight path vector FPV, and so as to move the discontinuity over the graphical object over time.

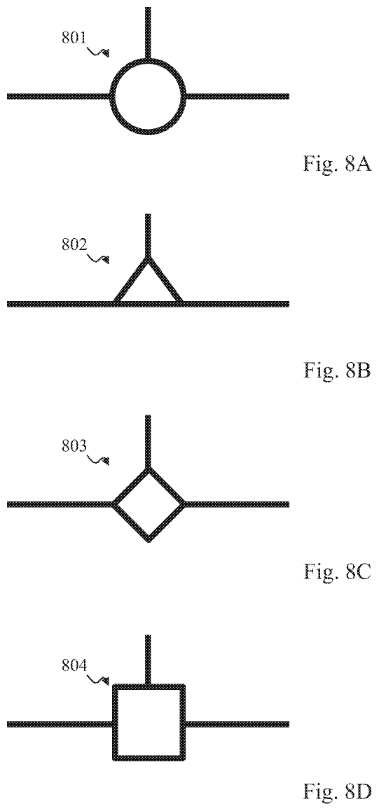

FIGS. 8A through 8D schematically illustrate a fourth example of successive form changes made to a graphical object displayed via the display 201b.

FIG. 8A shows a graphical object 801 corresponding to the graphical object 400.

FIG. 8B shows a graphical object 802 derived from the graphical object 400. The graphical object 802 differs from the graphical object 400 in that the circle 401 is replaced with a triangle whose vertices correspond to the points of connection of the segments 402, 403, 404 to the circle 401 on the graphical object 400.

FIG. 8C shows a graphical object 803 derived from the graphical object 400. The graphical object 803 differs from the graphical object 400 in that the circle 401 is replaced with a square three vertices of which correspond to the points of connection of the segments 402, 403, 404 to the circle 401 on the graphical object 400.

FIG. 8D shows a graphical object 804 derived from the graphical object 400. The graphical object 804 differs from the graphical object 400 in that the circle 401 is replaced with a square three midpoints of respective sides of which correspond to the points of connection of the segments 402, 403, 404 to the circle 401 on the graphical object 400.

By successively displaying FIGS. 8A through 8D, the part of the graphical representation of the flight path vector FPV that corresponds the fuselage of the aircraft 100 changes unitary geometric form.

FIGS. 8A through 8D thus show an example of display control, by the display 201b, in which the control system CTRL 300 switches part of the graphical object between unitary geometric forms.

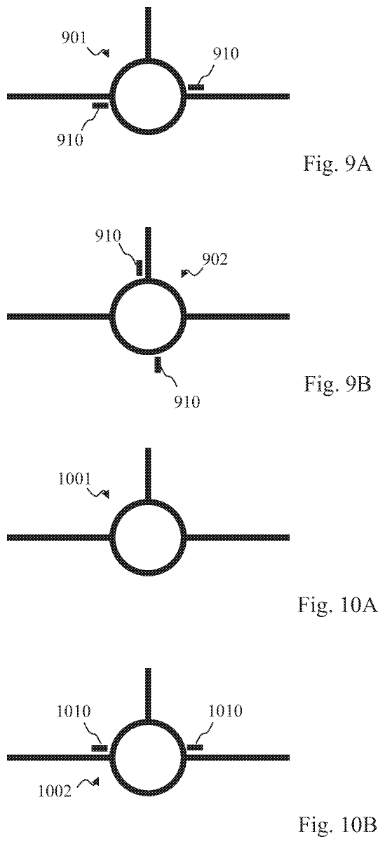

FIGS. 9A through 9B schematically illustrate a fifth example of successive form changes made to a graphical object displayed via the display 201b.

FIG. 9A shows a graphical object 901 derived from the graphical object 400. The graphical object 901 differs from the graphical object 400 in that additional segments 910, of a size smaller than the segments 402, 403, 404, are added. One of these additional segments 910 is placed above the horizontal segment 404, and another of these additional segments 910 is placed below the horizontal segment 403, symmetrically about the center of the circle 401.

FIG. 9B shows a graphical object 902 derived from the graphical object 400. The graphical object 902 also differs from the graphical object 400 in that the additional segments 910 are added, but at different positions from their respective positions in FIG. 9A. In FIG. 9B, the additional segments 910 have undergone a 90° rotation about the center of the circle 401.

By successively displaying FIGS. 9A and 9B, the additional segments 910 move.

FIGS. 10A through 10B schematically illustrate a sixth example of successive form changes made to a graphical object displayed via the display 201b.

FIG. 10A shows a graphical object 1001 corresponding to the graphical object 400.

FIG. 10B shows a graphical object 1002 derived from the graphical object 400. The graphical object 1002 differs from the graphical object 400 in that additional segments 1010, of a size smaller than the segments 402, 403, 404, are added. One of these additional segments 1010 is placed above the horizontal segment 404, and another of these additional segments 1010 is placed above the horizontal segment 403, symmetrically about a vertical axis incorporating the vertical segment 402.

By successively displaying FIGS. 10A and 10B, the additional segments 1010 appear and disappear.

FIGS. 9A and 9B and 10A and 10B thus show examples of display control, by the display 201b, in which the control system CTRL 300 intermittently displays graphical elements in addition to a nominal graphical object, formed by the graphical object 400.

FIGS. 5A through 5C, 6A through 6D, 7A through 7C, 8A through 8D, 9A and 9B, and 10A and 10B thus show examples of display control, by the display 201b, in which the control system CTRL 300 intermittently changes the geometric form of a graphical object in the form of which piloting assistance information is displayed by the display 201n. This makes it possible to combat effects of binocular rivalry. As an alternative or in addition, the control system CTRL 300 intermittently changes the color of one or more parts of the graphical object in question.

Thus, in one particular embodiment, the control system CTRL 300 displays the discontinuity, as outlined with reference to FIGS. 5A through 5C, 6A through 6C and 7A through 7C, in a different color from the rest of the graphical object. For example, by pressing on a flight path vector FPV displayed in green on a black background, the discontinuity is displayed in white.

In another particular embodiment, the control system CTRL 300 displays the additional graphical elements, as outlined with reference to FIGS. 9B and 10B, in a different color from the rest of the graphical object. For example, by pressing on a flight path vector FPV displayed in green on a black background, the additional graphical elements are displayed in white.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A monocular display system for an aircraft comprising:
a display for mounting fixedly on a head of a user in a cockpit of the aircraft;
a display control system for generating a video signal to be displayed by the display on a basis of piloting assistance information to be presented to the user in a form of a graphical object; and
the display control system comprising electronic circuitry configured to intermittently change geometric form and/or color of one or more parts of the graphical object to combat binocular rivalry by attracting attention of a brain of the user to the display.

2. The monocular display system for an aircraft according to claim 1, wherein, to intermittently change the geometric form of one or more parts of the graphical object, the electronic circuitry is configured to display a discontinuity in part or parts of the graphical object and to move the discontinuity over the graphical object over time.

3. The monocular display system for an aircraft according to claim 1, wherein, to intermittently change the geometric form of one or more parts of the graphical object, the electronic circuitry is configured to switch part of the graphical object between unitary geometric forms.

4. The monocular display system for an aircraft according to claim 1, wherein, to intermittently change the geometric form of one or more parts of the graphical object, the electronic circuitry is configured to intermittently display graphical elements in addition to a nominal graphical object.

5. The monocular display system for an aircraft according to claim 1, wherein the piloting assistance information to be presented to the user in the form of a graphical object is at least a flight path vector.

6. The monocular display system for an aircraft according to claim 1, wherein the electronic circuitry is configured to intermittently change the geometric form and/or the color of the part or parts of the graphical object:
continuously; or
in a stroboscopic manner; or
in a pulsed manner.

7. The monocular display system for an aircraft according to claim 6, wherein the form and/or color is configured to change at a fixed period of between 1 and 3 seconds.

8. An aircraft including a monocular display system for an aircraft comprising:
a display for mounting fixedly on a head of a user in a cockpit of the aircraft;
a display control system for generating a video signal to be displayed by the display on a basis of piloting assistance information to be presented to the user in a form of a graphical object; and
the display control system comprising electronic circuitry configured to intermittently change geometric form and/or color of one or more parts of the graphical object to combat binocular rivalry by attracting attention of a brain of the user to the display.
